(19) United States
(12) Patent Application Publication
(10) Pub. No.: US 2006/0265579 A1
(43) Pub. Date: Nov. 23, 2006

(54) Computer system and control method

(75) Inventor: Seong-hwan Seol, Incheon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/132,455

(22) Filed: May 19, 2005

(30) Foreign Application Priority Data
May 19, 2005 (KR) 10-2004-0035428

(51) Int. Cl. G06F 15/177

(52) U.S. Cl. 713/1

(57) ABSTRACT

A computer system, and a method of controlling the same, including a selector to select one of a plurality of startup modes to perform different functions in the computer system, wherein at least one of the startup modes includes initializing less than an entirety of hardware components of the computer system during a booting of the computer system.

### CROSS-REFERENCE TO RELATED APPLICATIONS

This application claims the priority of Korean Patent Application No. 2004-35428, filed on May 19, 2004, in the Korean Intellectual Property Office, the disclosure of which is incorporated herein by reference.

### BACKGROUND OF THE INVENTION

1. Field of the Invention

The present invention relates to a computer system and a method of controlling the same, and more particularly, a computer system and a control method of selecting one of a plurality of startup modes using a jog lever unit, and thus booting the computer system from a selected startup mode while reducing booting time.

2. Description of the Related Art

Recently, the uses of a computer system and applications thereof have been widely extended, and have begun to require multiple operating systems or working environments to be available in one computer system. Computer systems such as this are currently commercially available.

For example, the WINDOWS® series developed by MICROSOFT CORP., allows multiple users to customize their own operating systems or working environment and perform respectively in one computer system. Accordingly, the multiple users need to enter their IDs (Identifications) together with passwords when the computer system is booted. Accordingly, the computer system performs so as to present the customized working environment corresponding to the entered ID and the password.

With such a conventional operating system, a booting process of the computer system is as follows. At first, each of a plurality of hardware components in the computer system is initialized by a BIOS (Basic Input Output System) stored in a ROM (Read Only Memory) BIOS. Then, the BIOS finds any errors in each of the hardware components by running a POST (Power On Self Test) process, and performs a process of launching an operating system. Then, the computer system is booted from the operating system by executing a startup program stored on a recording medium such as a floppy disk drive, a hard disk drive, or an optical disk drive.

Further, the operating system requires the user to enter the ID and the password when the computer system is booted, and accordingly the computer system performs under the working environment customized by the user.

However, there is a problem when the computer system is booted from the user-customized operating system or working environment through the above process. For example, if the user wants to play back a moving picture file stored in a DVD through a DVD drive, the computer system is booted through the above process. In this case, the BIOS is executed to boot the computer system from an operating system while initializing hardware components and running the POST process, but these processes are irrelevant to playing back the moving picture files. Accordingly, booting time is unnecessarily slowed down due to the initialization and POST process for hardware and software components that are not required to play back the DVD. Further, if the computer system is a portable computer operated by a battery, power is unnecessarily supplied to the hardware components that are not used in the user-customized operating system.

### SUMMARY OF THE INVENTION

Accordingly, it is an aspect of the present invention to provide a control method and a computer system using the control method so that the computer system can be booted from a plurality of startup modes to perform different functionalities in one computer, and thereby reduce a booting time.

In addition, the control method and the computer system using the control method provide a UI (User Interface), and thus a user can easily select one of the plurality of startup modes.

Further, a unit used to select one of the plurality of startup modes in the present invention may be applied to other usages.

Additional aspects and/or advantages of the invention will be set forth in part in the description which follows and, in part, will be obvious from the description, or may be learned by practice of the invention.

The foregoing and/or other aspects of the present invention may be achieved by providing a computer system comprising a jog lever unit to generate a plurality of control signals to select one of a plurality of startup modes to perform different functions; and a controller to boot the computer system using the selected startup mode according to the control signals.

The controller may comprise an operating system storage to store one or more operating systems from which the computer system is booted based on the selected startup mode, and a system startup part comprising a startup routine through which the computer system is booted from the selected operating system.

The system startup part may comprise a startup routine storage to store the startup routine, and a microcomputer to run the startup routine to boot the computer system from the selected operating system according to the control signal.

The startup routine may comprise a BIOS.

The startup mode may comprise a first startup mode and a second startup mode, wherein the first startup mode requires the entire computer system to be booted from the operating system.

The microcomputer may activate predetermined components of the computer system to be operated for the second startup mode in response to receiving the control signal indicating the second startup mode.

The second startup mode may comprise an audio startup mode outputting audio data.

The microcomputer may determine the control signal to an interrupt signal and accordingly become activated in response to receiving the control signal from the jog lever unit while in a standby mode.

The microcomputer may be returned to the standby mode in response to not receiving an additional control signal from the jog lever unit during a predetermined time period after being activated by the interrupt signal.

The computer system may further comprise an optical disk drive to play back data stored an optical disk, wherein the second startup mode comprises a multimedia playback mode to play back the data stored in the optical disk.

The startup routine may initialize all necessary components to boot the computer system from the first startup mode.

According to another embodiment of the present invention, a method of controlling a computer system comprises setting a plurality of startup modes to perform different functions; selecting one of the plurality of startup modes by operating a jog lever unit; and booting the computer system from the selected startup mode using the jog lever unit.

The startup modes may comprise a first startup mode and a second startup mode, and the selecting one of the plurality of startup modes by operating the jog lever unit may comprise preparing at least one operating system to boot the computer system from the first startup mode and preparing a startup routine to boot the computer system from the at least one operating system.

The booting the computer system from the startup mode may comprise activating predetermined components corresponding to the second startup mode.

The booting the computer system from startup mode may comprise executing the startup routine in response to the first startup mode being selected; and booting the computer system from the operating system corresponding to the startup routine, wherein the startup routine initializes necessary components to boot the computer according to the first startup mode.

According to another embodiment of the present invention, a computer system comprises a startup mode selector to select one of a plurality of startup modes to perform different functions; and a controller to comprise a plurality of startup rountines corresponding to the respective startup modes, and to initialize the computer system in response to the startup routine selected by the startup mode selector.

The controller may further comprise an operating system storage to store one or more operating systems to boot the computer system from one or more startup modes; wherein one or more startup routines initialize the computer system in response to the selection of the tartup mode selector and then boot the computer system from an operating system between the operating systems stored in the operating system storage.

At least one startup routine activates predetermined components only to boot the computer system according to the corresponding startup mode.

The computer system further comprises a power supply to supply power to each of the components of the computer system, wherein one or more startup routines control the power supply to supply power to the predetermined components only to boot the computer system according to the corresponding startup mode.

The startup mode selector may comprise a jog lever unit to output a plurality of control signals to select the startup modes.

According to another embodiment of the present invention, a computer system comprises a selector to select one of a plurality of startup modes to perform different functions in the computer system; wherein at least one of the startup modes comprises initializing less than an entirety of hardware components of the computer system during a booting of the computer system.

The computer system further comprises a controller to boot the computer system according to the selected startup mode.

The controller may receive a control signal from the selector, and accordingly boots the computer system according to the selected startup mode.

The selector may be a multi-directional unit that is manipulated by a user to select a desired startup mode.

The selector may be a jog lever unit provided in a casing of the computer system.

The jog lever unit may generate a control signal according to the manipulation by the user.

The selector may be used as an input device to perform a predetermined function after selecting the startup mode.

The input device may be used to provide input with a graphical user interface provided by the computer system.

The input device may be used as a hotkey to activate software.

The software may be an Internet browser.

The selector may be used to activate the computer system from a standby mode.

According to another embodiment of the present invention, an interrupt signal from the selector activates the computer system from the standby mode, and a control signal from the selector then indicates the selected startup mode in response to the control signal occurring within a predetermined timer after interrupt signal.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a control block diagram of a computer system according to an embodiment of the present invention;

FIG. 2 is a perspective view of one possible form of the computer system according to the embodiment of the present invention shown in FIG. 1;

FIG. 3 is a detailed control block diagram of the computer system according to the embodiment of the present invention shown in FIG. 1;

FIG. 4 illustrates a method of controlling a computer system according to an embodiment of the present invention;

FIG. 5 illustrates a UI (User Interface) of a computer system according to an embodiment of the present invention; and

FIG. 6 describes another application of a jog lever unit of a computer system according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

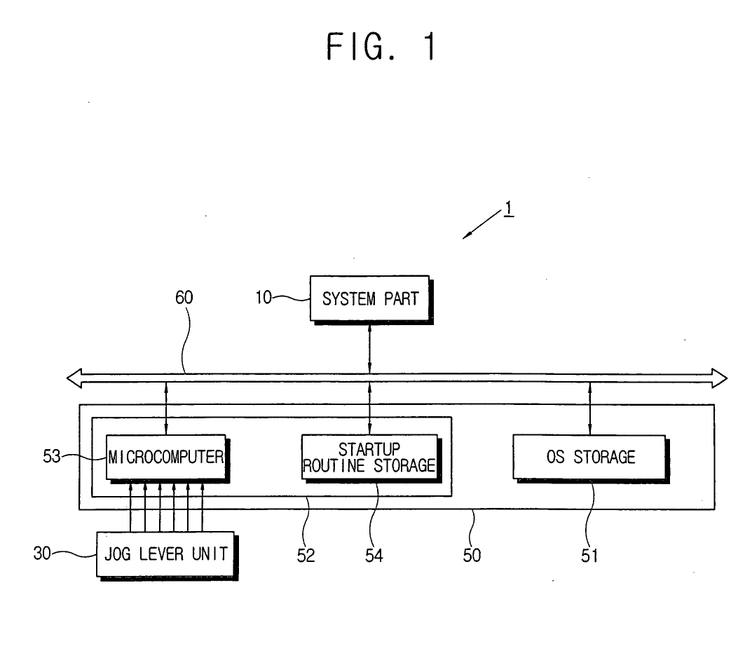

As shown in FIG. 1, a computer system 1 according to an embodiment of the present invention comprises a system part 10 comprised of a plurality of hardware components; a jog lever unit 30 generating a plurality of control signals to select one of a plurality of startup modes respectively supporting different functions; and a controller 50 booting the system part 10 from the selected startup mode corresponding to the control signal generated by the jog lever unit 30. Although the jog lever unit 30 is described in the discussed embodiments, a number of other possible embodiments are available with which to choose from the plurality of startup modes respectively supporting different functions.

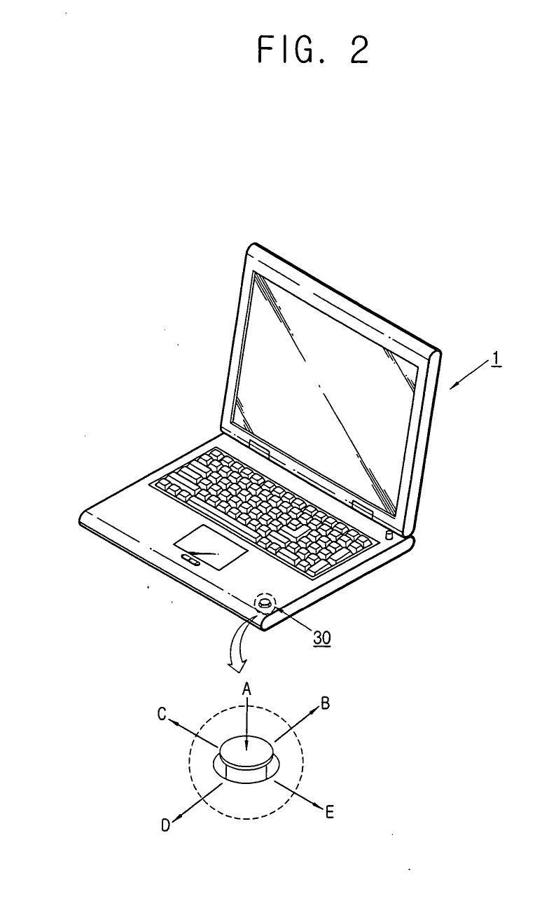

The jog lever unit 30 is provided in a portion of the computer system 1. FIG. 2 is a perspective view of one possible form of the computer system 1 illustrated in FIG. 1. According to FIG. 2, the computer system 1 is a portable computer, and the jog lever unit 30 is provided in a main body thereof.

As illustrated by the expanded view of the jog lever unit 30 in FIG. 2, a user can operate the jog lever unit 30 by adjusting it upward (Direction B), downward (Direction D), leftward (Direction C), and rightward (Direction E), and the jog lever unit 30 then generates a control signal corresponding to the user's operation. Further, if the user presses the jog lever unit 30 in a direction normal to an upper surface thereof (Direction A), the jog lever unit 30 generates a corresponding signal. Moreover, the jog lever unit 30 may generate respective control signals corresponding to diagonal directions of the Direction B, the Direction C, the Direction D, and the Direction E, as necessary.

Hereinbelow, the control signals generated from the jog lever unit 30 are temporarily named as A-control signal, B-control signal, C-control signal, D-control signal and E-control signal corresponding to the respective operations toward the A Direction, the B Direction, the C Direction, the D Direction, and the E Direction, as shown in FIG. 2.

Observing FIG. 1, the controller 50 according to this embodiment of the present invention comprises an OS (Operating System) storage 51 storing an operating system to boot the computer system, and a system startup unit 52 having a startup routine to run the computer system from the stored operating system through the startup routine.

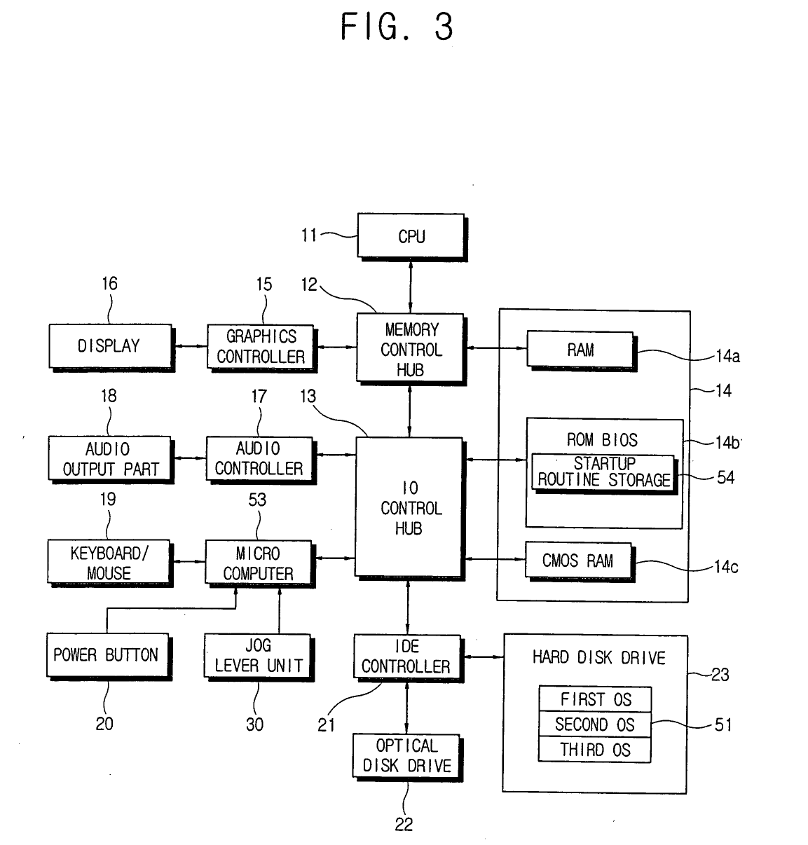

Herein, the system startup unit 52 comprises a startup routine storage 54 storing the startup routine, and a microcomputer 53 executing the startup routine to boot the computer system from the operating system corresponding to a control signal generated from the jog lever unit 30. The startup routine according to this embodiment of the present invention may include a BIOS (Basic Input Output System), and accordingly the startup routine storage 54 may include a ROM BIOS 14b (which will be described later in reference to FIG. 3).

The reference numeral 60 in FIG. 1 indicates a bus transmitting data between each of components of the computer system 1.

FIG. 3 is a detailed control block diagram of the computer system 1 according to this embodiment of the present invention. Herein, the startup routine storage 54 is the ROM BIOS 14b, and the OS storage 51 is contained in a hard disk drive 23.

The system part 10 comprises a CPU (Central Processing Unit) 11; a memory 14; a graphics controller 15 connected to a display 16 and providing a video signal to the display 16; an audio controller 17 connected to an audio output part 18 and providing an audio signal to the audio output part 18; an IDE controller 21; an MCH (Memory Control Hub) 12; and an ICH (Input/Output Control Hub) 13.

The memory 14 comprises a RAM (Random Access Memory) 14a, which is a non-volatile memory, the ROM BIOS 14b storing the BIOS and the startup routine, and a CMOS RAM 14c.

The MCH 12 is a chipset managing the RAM 14a as a main memory and data traveling between the CPU 11, the RAM 14a, and the graphics controller 15. Herein, the graphics controller 15 can be replaced by a GMCH (Graphic Memory Control Hub) as a chipset with the MCH 12.

As shown in FIG. 3, the ICH 13 manages data traveling between the RAM 14a connected to the MCH 12 and other hardware components such as the ROM BIOS 14b, the CMOS RAM 14c, the audio controller 17, the microcomputer 53, and the IDE controller 21, excluding the graphics controller 15.

The IDE controller 21 controls the hard disk drive 23 and an optical disk drive 22 such as a DVD drive and/or CD drive. Herein, the hard disk drive 23 according to this embodiment of the present invention may store a plurality of operating systems.

Meanwhile, the operating system of the computer system 1 according to this embodiment of the present invention is divided into a main operating system and a plurality of sub operating systems. Herein, the main operating system is run through normal initialization and a booting process when the computer system 1 is turned on by a power button 20, as shown in FIG. 3. For example, the main operating system may be one of the WINDOWS® series developed by MICROSOFT CORP., and thus further description related thereto will be omitted.

The sub operating system is run through an initialization and booting process that has been simplified by a control method according to an embodiment of the present invention when a control signal is transmitted corresponding to an operation of the jog lever unit 30. For example, to play back multimedia contents using the optical disk drive 22 such as the DVD drive, a separate operating system may be provided to boot the computer system 1 from one of the plurality of startup modes customized to support multimedia functionality. In this case, the sub operating system requires indispensable software and related programs to play back the multimedia contents. According to this embodiment of the present invention, there are provided three sub operating systems stored on the OS storage 51; a first sub operating system, a second sub operating system, and a third sub operating system.

The startup mode according to this embodiment of the present invention is divided into a startup mode (hereinbelow, refer to “first startup mode”) booting the computer system from the sub operating system, and a startup mode (hereinbelow, refer to “second startup mode”) booting the computer system without executing the sub operating system. Herein, the first startup mode and the second startup mode will be described in detail through the control process of the computer system 1 according to the present invention.

Hereinbelow, the control process of the computer system 1 will be described.

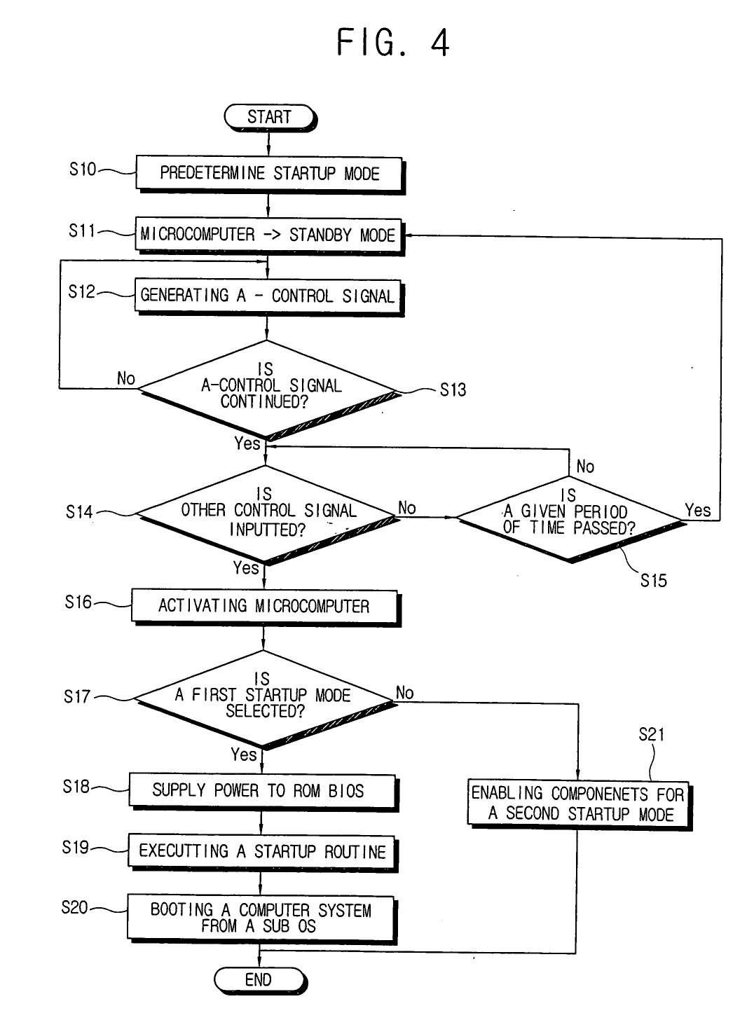

FIG. 4 illustrates a method of controlling a computer system according to an embodiment of the present invention. At first, each of the plurality of startup modes is predetermined in the computer system, and the startup modes are set to correspond to the control signals generated by operating the jog lever unit 30, at operation S10. For example, the B-control signal is set to boot up the computer system 1 from a first sub operating system among a first startup mode, the C-control signal is set to boot up the computer system 1 from a second sub operating system among the first startup mode, and the D-control signal is set to boot up the computer system 1 from a third sub operating system among the first startup mode. Meanwhile, the E-control signal is set to boot up the computer system 1 from the second startup mode.

Here, if the computer system 1 is powered off, the microcomputer 53 is maintained in a standby mode, at operation S11. If a user presses the jog lever unit 30 toward the A direction for a given time period, and thus the A-control signal is continuously generated for the given time period at operations S12 and S13, the microcomputer 53 determines the A-control signal to be an interrupt signal, and accordingly becomes activated.

The microcomputer 53, having been activated by the interrupt signal, in this case, the A-control signal, waits for the B-control signal, the C-control signal, the D-control signal, or the E-control signal, at operation S14. Herein, if the microcomputer 53 does not receive any signal within a given time period after being activated by the A-control signal, it returns to the standby mode, at operations S15 and S11.

Meanwhile, if the microcomputer 53 receives one of the B-control signal, the C-control signal, the D-control signal, or the E-control after being activated by the A-control signal, the microcomputer 53 performs a predetermined process to boot the computer system from a corresponding startup mode according to the received control signal, at operations S14 and S16.

The following embodiments are described below in order to explain how the microcomputer respectively performs when a user selects the startup modes.

At first, if the user selects the first sub operating system, of the first startup mode, as the startup mode at operation S17 using the jog lever unit 30, the jog lever unit 30 generates the B-control signal to be transmitted to the microcomputer 53.

Next, the microcomputer 53 controls the power supplier to supply power to the ROM BIOS 14b at operation S18. Then, the microcomputer 53 executes a corresponding startup routine stored in the ROM BIOS 14b to perform the first sub operating system at operation S19. Herein, the selected startup routine runs the POST (Power On Self Test) to initialize necessary hardware components supporting the first sub operating system. Accordingly, it reduces time that would be consumed during the conventional initialization and the POST process.

Then, the startup routine boots the computer system 1 from the first sub operating system stored in the hard disk drive 23 after the initialization and POST process are completed, at operation S20. Herein, the first sub operating system is simplified to provide a working environment customized to a minimum amount of operating system necessary for the first startup mode.

Meanwhile, if the user selects the second operating system using the jog lever unit 30 at operation S17, the jog lever unit 30 generates the E-control signal to the microcomputer 53, and the microcomputer 53 activates predetermined hardware components corresponding to the second startup mode at operation S21. Herein, the second startup mode is preferably, but not necessarily, an audio startup mode outputting audio format data, which can be booted from the predetermined hardware components without executing an operating system.

Meanwhile, the jog lever unit 30 of the computer system 1 according to another embodiment of the present invention can be used as an input device to perform a predetermined function after selecting a startup mode.

For example, if the computer system 1 is booted from the first startup mode, the sub operating system for the first startup mode may not support a common input device such as a keyboard or a mouse. Herein, the sub operating system activates a UI (User Interface), and a control signal for the UI may be generated from the jog lever unit 30. Herein, the microcomputer 53 detects the control signal from the jog lever unit 30, and thus controls the UI corresponding to the control signal.

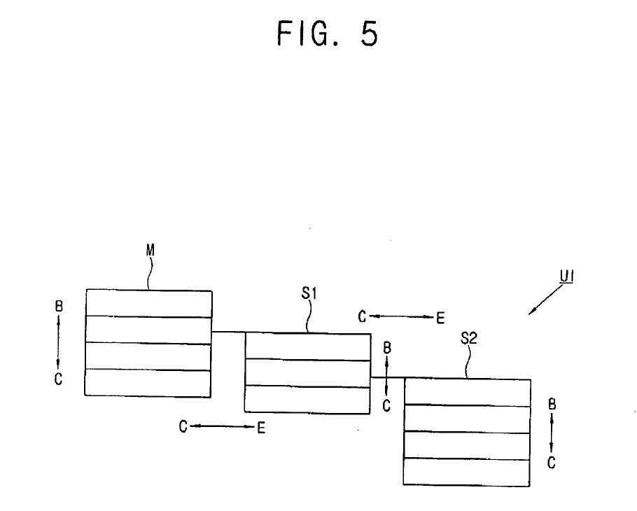

For example, if the jog lever unit 30 continuously receives the A-control signal for a given time period after the computer system 1 is booted from the first sub operating system, the microcomputer 53 transmits the consistent A-control signal to the CPU 11. Accordingly, the first sub operating system 53 displays the UI on the display 16, as shown in FIG. 5.

Herein, the UI is linked into a tree structure, and thus activates a main menu and a sub menu, which are linked to each other. Accordingly, the jog lever unit 30 may generate the A-control signal to select each of the main menus and the sub menus, and the B-control signal, the C-control signal, the D-control signal, and the E-control signal to select respectively a moving direction in and between the main menus and the sub menus.

Referring to FIG. 5, the process of utilizing the UI by operating the jog lever unit 30 is as follows.

First, when the A-control signal is generated during a predetermined time by operating the jog lever unit 30, the main menu M is displayed on the display 16. The main menu M may comprise a plurality of selection bars to select a certain function to be performed. At this time, the selection movement of the selection bars may be performed by the B-control signal and the C-control signal generated when the jog lever unit 30 operates. The selection of the selection bars may be performed by the A-control signal.

A user operates the jog lever unit 30 to generate the E-control signal, thereby shifting from the main menu M to the sub menu S1. The sub menu S1 may be displayed on the display 16 in the case that the E-control signal is generated, or displayed on the display 16 together with the main menu M.

Like in the main Menu M, the selection movement of the plurality of the selection bars provided in the sub menu S1 may be performed by the B-control signal and the C-control signal generated when the jog lever unit 30 operates. The selection of the selection bars may be performed by the A-control signal. Also, the shift from the sub menu S1 to another sub menu S2 may be performed by the E-control signal as described above. The shift from the sub menu S1 or S2 to the previous sub menu S1 to the main menu M may be performed by the C-control signal generated when the jog lever unit 30 operates.

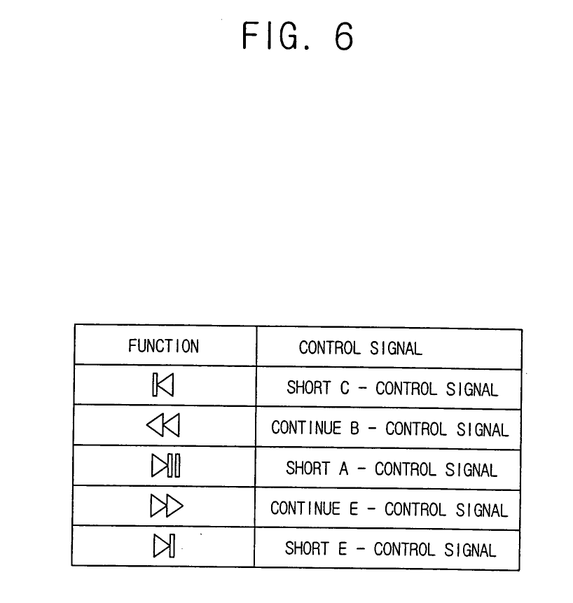

In addition, if the computer system 1 is booted from a startup mode customized to play back a movie or a music file, the jog lever unit 30 may be used to perform corresponding functions to play back the movie or the music file, as shown in FIG. 6. FIG. 6 shows an example of controlling the jog lever unit 30 when it is used to play back the movie or the music file, and the jog lever unit 30 may be applied to various other functions.

Meanwhile, the jog lever unit 30 may function as an input device when the computer system 1 is booted from a main operating system. For example, the jog lever unit 30 may be used as a hotkey to activate an Internet browser or software. Further, the jog lever unit 30 may be used as the input device to control a multimedia player playing back the movie or music files in the same manner as when the computer system 1 is booted from the sub operating system.

The computer system 1 can be booted from a startup mode customized to a user-preferable working environment by using the jog lever unit 30 to generate a plurality of signals to select one of various startup modes; and the controller 50 boots up the computer system 1 based on the signals corresponding to the selected startup mode.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A computer system comprising:
a jog lever unit to generate a plurality of control signals to select one of a plurality of startup modes to perform different functions; and
a controller to boot the computer system using the selected startup mode according to the control signals.

2. The computer system according to claim 1, wherein the controller comprises:
an operating system storage to store one or more operating systems from which the computer system is booted based on the selected startup mode; and
a system startup part comprising a startup routine through which the computer system is booted from the selected operating system.

3. The computer system according to claim 2, wherein the system startup part comprises:
a startup routine storage to store the startup routine; and
a microcomputer to run the startup routine to boot the computer system from the selected operating system according to the control signal.

4. The computer system according to claim 3, wherein the startup routine comprises a BIOS.

5. The computer system according to claim 3, wherein the plurality of startup modes comprises a first startup mode and a second startup mode, wherein the first startup mode requires the entire computer system to be booted from the operating system.

6. The computer system according to claim 5, wherein the microcomputer activates predetermined components of the computer system to be operated for the second startup mode in response to receiving the control signal indicating the second startup mode.

7. The computer system according to claim 6, wherein the second startup mode comprises an audio startup mode outputting audio data.

8. The computer system according to claim 3, wherein the microcomputer determines the control signal to be an interrupt signal and accordingly becomes activated in response to receiving the control signal from the jog lever unit while in a standby mode.

9. The computer system according to claim 8, wherein the microcomputer is returned to the standby mode in response to not receiving an additional control signal from the jog lever unit during a predetermined time period after being activated by the interrupt signal.

10. The computer system according to claim 5, further comprising:
an optical disk drive to play back data stored in an optical disk;
wherein the second startup mode comprises a multimedia playback mode to play back data stored in the optical disk.

11. The computer system according to claim 5, wherein the startup routine initializes all necessary components to boot the computer system from the first startup mode.

12. The computer system according to claim 2, wherein the controller determines the control signal from the jog lever unit to be a signal to perform a predetermined function in response to the computer system being booted from the selected startup mode.

13. A method of controlling a computer system, the method comprising:
setting a plurality of startup modes to perform different functions;
selecting one of the plurality of startup modes by operating a jog lever unit; and
booting the computer system from the selected startup mode using the jog lever unit.

14. The method of claim 13, wherein the plurality of startup modes comprises a first startup mode and a second startup mode, and the selecting one of the plurality of startup modes by operating the jog lever unit comprises preparing at least one operating system to boot the computer system from the first startup mode and preparing a startup routine to boot the computer system from the at least one operating system.

15. The method of claim 14, wherein the booting the computer system from the startup mode comprises activating predetermined components corresponding to the second startup mode.

16. The method of claim 14, wherein the booting the computer system from startup mode comprises:
executing the startup routine in response to the first startup mode being selected; and
booting the computer system from the operating system corresponding to the startup routine;
wherein the startup routine initializes necessary components to boot the computer according to the first startup mode.

17. A computer system comprising:
a startup mode selector to select one of a plurality of startup modes to perform different functions; and
a controller to comprise a plurality of startup rountines corresponding to the respective startup modes, and to initialize the computer system in response to the startup routine selected by the startup mode selector.

18. The computer system according to claim 17, wherein the controller further comprises an operating system storage to store one or more operating systems to boot the computer system from one or more startup modes; wherein one or more startup routines initialize the computer system in response to the selection of the startup mode selector and then boot the computer system from an operating system between the operating systems stored in the operating system storage.

19. The computer system according to claim 18, wherein at least one startup routine activates predetermined components only to boot the computer system according to the corresponding startup mode.

20. The computer system according to claim 18, further comprising: a power supply to supply power to each of the components of the computer system, wherein one or more startup routines control the power supply to supply power to the predetermined components only to boot the computer system according to the corresponding startup mode.

21. The computer system according to claim 19, wherein the startup mode selector comprises a jog lever unit to output a plurality of control signals to select the startup modes.

22. A computer system comprising:
a selector to select one of a plurality of startup modes to perform different functions in the computer system;
wherein at least one of the startup modes comprises initializing less than an entirety of hardware components of the computer system during a booting of the computer system.

23. The computer system according to claim 22, further comprising a controller to boot the computer system according to the selected startup mode.

24. The computer system according to claim 23, wherein the controller receives a control signal from the selector, and accordingly boots the computer system according to the selected startup mode.

25. The computer system according to claim 22, wherein the selector is a multi-directional unit that is manipulated by a user to select a desired startup mode.

26. The computer system according to claim 25, wherein the selector is a jog lever unit provided in a casing of the computer system.

27. The computer system according to claim 26, wherein jog lever unit generates a control signal according to the manipulation by the user.

28. The computer system according to claim 25, wherein the selector is used as an input device to perform a predetermined function after selecting the startup mode.

29. The computer system according to claim 28, wherein the input device is used to provide input with a graphical user interface provided by the computer system.

30. The computer system according to claim 28, wherein the input device is used as a hotkey to activate software.

31. The computer system according to claim 30, wherein the software is an Internet browser.

32. The computer system according to claim 22, wherein the selector is used to activate the computer system from a standby mode.

33. The computer system according to claim 32, wherein an interrupt signal from the selector activates the computer system from the standby mode, and a control signal from the selector then indicates the selected startup mode in response to the control signal occurring within a predetermined timer after interrupt signal.
